(19) United States
(12) Patent Application Publication
(10) Pub. No.: US 2016/0219046 A1
(43) Pub. Date: Jul. 28, 2016

(54) SYSTEM AND METHOD FOR MULTI-MODAL BIOMETRIC IDENTITY VERIFICATION

(71) Applicant: Identity Validation Products, LLC, Daingerfield, TX (US)

(72) Inventors: CLAUDIO R. BALLARD, FORT LAUDERDALE, FL (US); SANDY FLIDERMAN, ALBERTSON, NY (US); BRIAN HUEMPFNER, BURKE, VA (US)

(21) Appl. No.: 14/016,032

(22) Filed: Aug. 30, 2013

Related U.S. Application Data
(60) Provisional application No. 61/694,770, filed on Aug. 30, 2012.
(60) Provisional application No. 61/695,214, filed on Aug. 30, 2012.
(60) Provisional application No. 61/726,572, filed on Nov. 14, 2012.

(51) Int. Cl. H04L 29/06

(52) U.S. Cl. CPC H04L 63/0861; H04L 63/123; H04L 63/10

(57) ABSTRACT

In one example of a system and method for multi-modal biometric identity verification, a system receives a request from a device to verify a user's identity. The request includes a payload encrypted using keys derived from a biometric minutia set based on the user's biometric data. The system retrieves biometric data corresponding to an enrolled user, generates a decryption key based on a biometric minutia set derived from the retrieved biometric data, and decrypts the payload. Biometric data extracted from the payload is compared to biometric data corresponding to the enrolled user to produce a comparison result. The result is used to identify a value representing a probability that the biometric data matches. The system calculates a verification score representing a level of confidence that the user is the enrolled user if the value meets or exceeds a threshold and sends the score or a representation thereof to the device.

### CROSS-REFERENCE TO RELATED APPLICATIONS

This application claims benefit of U.S. Provisional Application No. 61/694,770, filed Aug. 30, 2012, entitled METHOD AND APPARATUS FOR ADVANCED MULTI-MODAL BIOMETRIC VERIFICATION (Atty. Dkt. No. VMVM-31434), U.S. Provisional Application No. 61/695,214, filed Aug. 30, 2012, entitled METHOD AND APPARATUS FOR ADVANCED MULTI-MODAL BIOMETRIC VERIFICATION (Atty. Dkt. No. VMVM-31436), and U.S. Provisional Application No. 61/726,572, filed Nov. 14, 2012, entitled SYSTEM AND METHOD FOR COMBINED BIOMETRIC AUTHENTICATION (Atty. Dkt. No. VMVM-31497), the specifications of which are incorporated herein by reference in their entirety.

### TECHNICAL FIELD

The following disclosure relates to security methods for sign-on authentication, payment presentment and auto-field population for authorized web sites. More specifically, it relates to security methods utilizing a two or more biometric authentication identifiers for the purposes of establishing the identity of the user and that the user is a live person.

### BACKGROUND

There currently exist many problems relating to the verification and management of on-line identities. As society increasingly relies on on-line activity for work, research, banking, recreation, shopping, etc., the consequences of poor identity verification become increasingly severe. For example, there prolific problems are created by anonymous and/or proxy users of blogs, social networks, media and general websites' author and/or comments sections. Further, there is an on-line epidemic of identity thefts, fraud, threats, slander, defamation, bullying, impersonations, etc. by anonymous or fraudulent “authors,” of blogs, profiles on the Facebook™ social media site (or similar social network sites), published articles, references, users, “sellers” and “commentors.” A need therefore exists, for improved methods to verify the identity of on-line users.

It is known that selected social network sites and other on-line sites (i.e., “platforms”) utilize vetting of one type or another to verify the identity of their users. However, the results of such verification efforts are typically applicable only to that platform. A need therefore exists, for verification methods that are applicable across multiple platforms, and a further need for corresponding indicia that are recognized across multiple platforms.

Using biometric user data to verify user identity is relatively convenient to the user, while being difficult for others to fraudulently reproduce. U.S. Pat. No. 7,519,558 to Ballard et al. describes certain technology relating to biometric identity verification. U.S. Pat. No. 7,519,558, including all specification, description, figures and claims, is hereby incorporated by reference.

### SUMMARY

In one embodiment, there is provided an advanced multi-modal biometric method for single sign-on authentication, payment presentment and auto-field population for authorized web sites. This invention utilizes a combined biometric authentication approach (two or more of fingerprint, facial recognition, iris-scan, voice or touch point swipe) for the purposes of establishing the identity of the user and that the user is live when presenting such credentials for authentication and verification.

In another aspect of the invention, a method for execution by a verification system comprises receiving, by the verification system, a request from a device to verify an identity of a user of the device, wherein the request includes a data payload encrypted using a plurality of first keys derived from a first biometric minutia set, wherein the first biometric minutia set is derived from first biometric data obtained by the device for the request from at least one biometric feature of the user, and wherein the first biometric minutia set is only a subset of the first biometric data. The verification system retrieves second biometric data from a database, wherein the second biometric data corresponds to an enrolled user having a maximum identification (MaxID) score associated therewith within the verification system. The verification system further generates a second biometric minutia set from the second biometric data, generates a second key derived from the second biometric minutia set, decrypts the data payload using the second key and extracts third biometric data from the data payload. The third biometric data was obtained by the device for the request from at least one biometric feature of the user. The verification system compares the third biometric data to fourth biometric data corresponding to the enrolled user to produce a comparison result. Using the comparison result, the verification system identifies a value representing a probability that the third biometric data matches the fourth biometric data. The verification system acts on the value, wherein the acting includes calculating a verification score representing a level of confidence by the verification system that the user of the device is the enrolled user if the value meets or exceeds a threshold value and sending the verification score or a representation thereof to the device.

In one embodiment of the method, the first biometric minutia set is identical to the third biometric data and the second biometric minutia set is identical to the fourth biometric data.

In another embodiment, the first biometric minutia set is different from the third biometric data and the second biometric minutia set is different from the fourth biometric data.

In yet another embodiment, the verification score is calculated based on the MaxID and the value.

In a still further embodiment, the acting further includes storing the third biometric data as fraudulent if the value does not meet or exceed the threshold value.

In another embodiment, the verification score is expressed as a qualitative value.

In another embodiment, the verification score is expressed as a quantitative value.

In yet another embodiment, the step of decrypting the data payload includes: attempting to decrypt each of a plurality of separately encrypted blocks in the data payload using the second key until a single one of the blocks is successfully decrypted because the second key matches the first key used to encrypt that block; extracting a remaining plurality of the first keys from the decrypted block; and decrypting the remaining blocks using the remaining plurality of first keys.

In yet another aspect of the invention, a method for execution by a device comprises the following steps: receiving, by the device, an access request from a user of the device; obtaining, by the device, first biometric data from the user in response to the access request; generating, by the device, a biometric minutia set from the first biometric data; generating, by the device, a plurality of encryption keys from the biometric minutia set; encrypting, by the device using the encryption keys, a data payload containing second biometric data obtained from the user; sending, by the device, a verification message to a verification system, wherein the verification message contains the encrypted data payload and requests that the verification system verify an identity of the user based on the encrypted data payload; and receiving, by the device, a response to the request, wherein the response indicates whether the access request is to be granted based on whether the identity of the user was verified.

In another embodiment of the method, the first biometric data is identical to the second biometric data.

In yet another embodiment, the first biometric minutia set is identical to the second biometric data.

In a further embodiment, generating the plurality of encryption keys includes: obtaining a plurality of unique scans from the first biometric data; generalizing the unique scans to exclude any point not replicated in each scan; discarding any duplicative scans from the generalized scans to identify a plurality of distinct scans; and generating a separate encryption key for each of the distinct scans.

In another embodiment, encrypting the data payload includes: dividing the data payload into a number of sections equal to the number of separate encryption keys; and encrypting each section with a single one of the encryption keys.

In yet another embodiment, the method further comprises, for each section, appending the encryption keys not used to encrypt the section to the section before encrypting the section.

In a further aspect of the invention, a verification system comprises: a network interface; a processor coupled to the network interface; a memory coupled to the processor and containing instructions for execution by the processor. The instructions include instructions for: (a) receiving a request from a device via the network interface to verify an identity of a user of the device, wherein the request includes a data payload encrypted using a plurality of first keys derived from a first biometric minutia set, wherein the first biometric minutia set is derived from first biometric data obtained by the device for the request from at least one biometric feature of the user, and wherein the first biometric minutia set is only a subset of the first biometric data; (b) retrieving second biometric data from a database, wherein the second biometric data corresponds to an enrolled user having a maximum identification (MaxID) score associated therewith within the verification system; (c) generating a second biometric minutia set from the second biometric data; (d) generating a second key derived from the second biometric minutia set; (e) decrypting the data payload using the second key; (f) extracting third biometric data from the data payload, wherein the third biometric data was obtained by the device for the request from at least one biometric feature of the user; (g) comparing the third biometric data to fourth biometric data corresponding to the enrolled user to produce a comparison result; (h) identifying, using the comparison result, a value representing a probability that the third biometric data matches the fourth biometric data; and (i) acting on the value, wherein the acting includes calculating a verification score representing a level of confidence by the verification system that the user of the device is the enrolled user if the value meets or exceeds a threshold value and sending the verification score or a representation thereof to the device.

In another embodiment of the system, the first biometric minutia set is identical to the third biometric data and the second biometric minutia set is identical to the fourth biometric data.

In yet another embodiment, the first biometric minutia set is different from the third biometric data and the second biometric minutia set is different from the fourth biometric data.

In still another embodiment, the verification score is calculated based on the MaxID and the value.

In a further embodiment, the verification score is expressed as a qualitative value.

In another embodiment, the verification score is expressed as a quantitative value.

### BRIEF DESCRIPTION OF THE DRAWINGS

For a more complete understanding, reference is now made to the following description taken in conjunction with the accompanying Drawings in which:

FIG. 1 illustrates one embodiment of an environment in which biometric authentication may be performed for a user of a device;

FIG. 2 illustrates one embodiment of a method for performing biometric authentication within the environment of FIG. 1;

FIG. 3 illustrates one embodiment of a biometric authentication process driven by a user;

FIG. 4 illustrates one embodiment of a biometric authentication process driven by an application with which a user is interacting;

FIG. 5 illustrates one embodiment of an information set collected in connection with a specific user that may be stored in a verification system in the environment of FIG. 1;

FIGS. 6A and 6B illustrate one embodiment of a method for performing biometric authentication within the environment of FIG. 1;

FIGS. 6C and 6D illustrate another embodiment of a method for performing biometric authentication, the method being similar to that shown in FIGS. 6A and 6B;

FIGS. 7-12 illustrate various embodiments of biometric encryption methods that may be used for securely communicating information within the environment of FIG. 1; and

FIG. 13 illustrates one embodiment of a computer system that may be used within the environment of FIG. 1.

### DETAILED DESCRIPTION

Referring now to the drawings, wherein like reference numbers are used herein to designate like elements throughout, the various views and embodiments of system and method for multi-modal biometric identity verification are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

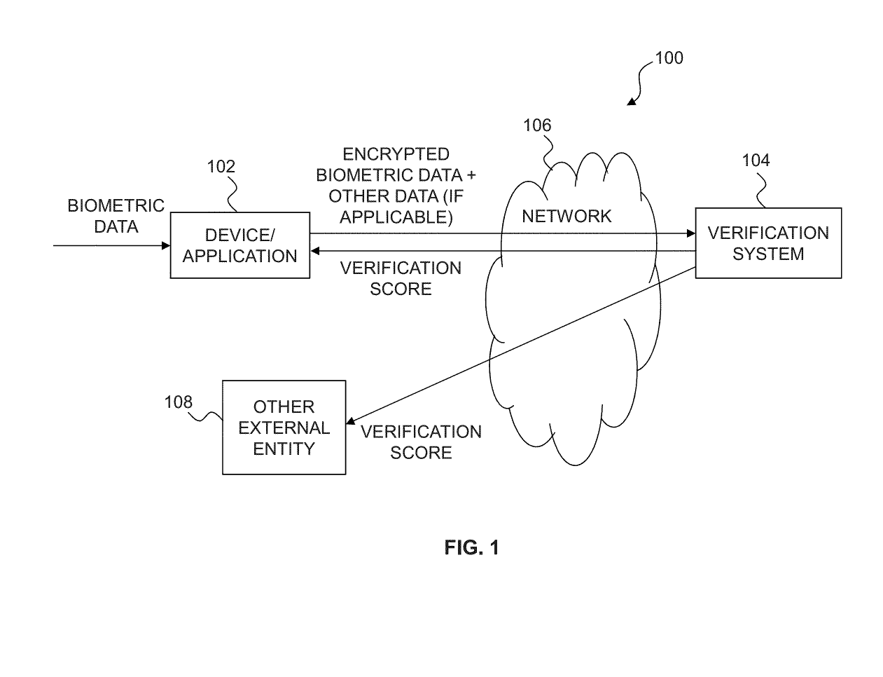

Referring to FIG. 1, one embodiment of an environment 100 is illustrated within which a device 102 may communicate with a verification system 104 via a network 106. The verification system 104 and/or processes used with such a system may also be referred to herein as the “VerifyMe” verification system or simply as “VerifyMe.” In the present example, the communications involve a biometric authentication process that is used to authenticate the identity of a user of the device 102. As will be described below in greater detail, the biometric authentication process collects biometric data via the device 102 and sends the biometric data and/or data derived from the biometric data to the verification system 104. In some embodiments, the device 102 may also send other data (e.g., device and/or subscriber identification data such as an International Mobile Station Equipment Identity (IMI) number, an International Mobile Subscriber Identity (IMSI) number, an electronic serial number (ESN), a media access control (MAC) address, location information (e.g., global positioning satellite (GPS) information), and/or other information).

The verification system 104 uses the received biometric data, biometrically-derived data and/or data from one or more other sources (not shown) to calculate a verification score. For example, the other data may be identical or similar to that described with respect to U.S. Pat. No. 7,519,558. The verification system 104 then sends the calculated verification score back to the device 102 and/or one or more other external entities 108. The device 102 and/or other external entity 108 may then use the received verification score to determine whether to authenticate the user. For example, the device 102 and/or other external entity 108 may compare the score to a defined threshold and either allow or deny authentication based on the comparison.

It is understood that the verification score and/or threshold may be modified based on a particular type of transaction. For example, assume that the biometric data and other data results in the calculation of a particular value by the verification system 104. If the authentication process is to confirm that a relatively small purchase is allowable, the value may be adjusted so that the verification score provides a relatively high level of confidence and/or the threshold may be set low so that a lower verification score will be sufficient. However, if the authentication process is to confirm that a relatively large amount of cash is to be withdrawn from a bank account via an automated teller machine (ATM), the value may be adjusted so that the verification score provides a relatively low level of confidence and/or the threshold may be set high. Accordingly, not only does the biometric authentication process provide a basic verification score, but how the score is used may be customized within the verification system 104, and/or at the device 102 and/or other external entity 108.

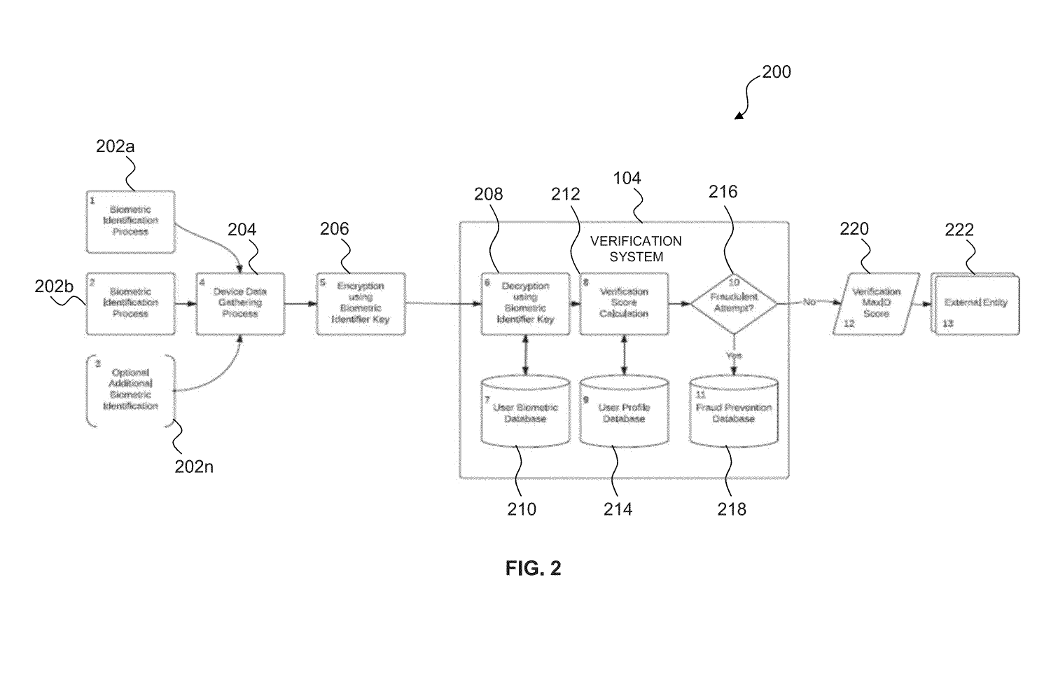

Referring to FIG. 2, one embodiment of a system process 200 that may be used within the environment of FIG. 1 is illustrated. In the present example, multiple biometric identification processes are run in steps 202a, 202b, . . . , 202n on one or more biometric identification systems, where “n” denotes the maximum number of biometric processes. The biometric processes may be repeated (e.g., multiple fingerprint scans) or may be unique (e.g., a fingerprint scan, a face scan, a voice scan, and a retina scan). Each biometric process 202a, 202b, . . . , 202n collects biometric data from the user, typically in real time. The collected biometric data may be stored locally (i.e., on the collecting device or without being transmitted over an unsecure network), e.g., for security purposes. The originally collected biometric data may be processed locally (i.e., on the collecting device or without being transmitted over an unsecure network) to produce a biometrically-derived data that is indicative of aspects of the originally collected biometric data, but that does not include the complete originally collected biometric data. This information is collected by the device 102 and it is understood that the biometric processes used may depend on the capabilities of the device 102. A biometric identification system may be based on fingerprints, facial recognition, iris-scan, voice and/or touch point swipe, although it is understood that these examples are not intended to be limiting.

In step 204, additional data may be gathered on the device 102. Such additional information may be biometric or non-biometric, and it may be user-supplied or derived from the device 102 or another system device. For example, the previously referenced IMI number, IMSI number, ESN, MAC address, location information (e.g., global positioning satellite (GPS) information), and/or other information may be gathered in this step.

In step 206, a data package is encrypted using a biometric identifier key (i.e., a “biometric encryption key”) derived from the biometric data, biometrically-derived data and/or other data previously collected. This encryption process is described below in greater detail, but generally uses an encryption key that is based on a generalization of unique biometric identifiers from one or more biometrics including but not limited to: fingerprint, facial recognition, iris-scan, voice, and/or touch point swipe. Preferably, the biometric identifiers used in the encryption of step 206 are derived from locally stored biometric data or biometrically-derived data from the biometric processes 202a, 202b, . . . , 202n. The data package encrypted in step 206 may include message data as well as biometric data, biometrically-derived data and/or other data previously collected.

In steps 208-218, a verification system 104 (which may be similar or identical to the verification system 104 of FIG. 1) receives and processes the encrypted data package, e.g., from step 206. More specifically, in step 208, the received encrypted data package is decrypted using a biometric identifier key (i.e., a “biometric decryption key”). The biometric identifier key used for decryption is preferably derived from independently obtained biometric data stored in a user biometric database 210 containing biometric data that was collected during an enrollment process and/or in subsequent data collection processes. The user biometric data in the user biometric database 210 may include, but is not limited to: facial images, facial recognition information/data, fingerprint information/data, iris scan information/data, voice recordings, voice recognition information/data, and/or touch point or finger swipe information/data. After decryption, the biometric data/information or biometrically-derived data/information received in encrypted data may be stored in the user biometric database 210. The other received data, e.g., the device data, email addresses, social media information/data, etc. and any message data may be stored in a user profile database 214. The user profile database 214 may contain user data collected during enrollment and each subsequent verification attempt including but not limited to: enrollment location, enrollment identity score, verification attempts, verification attempt locations, verification attempt time stamps, verification frequency, social network information, social network verification score, and verification device information.

Preferably, the verification system 104 restricts communications to/from external systems to the steps of receiving encrypted packages (step 206) and releasing verification scores/MaxID scores (step 220). The various proprietary processes described in steps 208, 212, and 216 are preferably conducted within a secure firewall such that communication with external systems is prevented. Further, the databases of the verification system 104, including the user biometric database 210, user profile database 214 and the fraud prevention database 218 are preferably maintained within the secure firewall for security purposes.

In step 212, a verification score is calculated based on, at least in part, a comparison of the biometric data, biometrically-derived data and/or other data received in the encrypted data from step 206 to the biometric data, biometrically-derived data and/or other data retrieved from the user biometric database 210 and user profile database 214. Step 212 may use any other data that the verification system 202 may be configured to use. The calculation of the verification score may use a combination of two or more biometric verifications, verification accuracy, previous verification patterns, verification location, social network verification, and/or a verification device trust score to determine a number with no maximum to indicate the validity of the user's identity.

In step 216, a determination may be made as to whether the authentication attempt is likely fraudulent. If the verification score falls below a defined threshold indicating that it is likely a fraudulent attempt, the information gathered during the verification attempt will be stored in a fraud prevention database 218 for the purpose of assisting any fraudulent claim actions. The fraud prevention database 218 may store all information collected during a verification attempt that is deemed fraudulent including but not limited to: user biometric data, e.g., images, finger prints, voice recordings and iris scans, unique device IDs, locations, and/or time stamps and/or and data derived from user biometric data. The fraud prevention database 218 may also store information collected during previous verification attempts by the same and/or different users that may be relevant to possible fraudulent requests.

If it is determined that the authentication attempt is not fraudulent, the verification score calculated in step 212 is transmitted from the verification system 104 in step 220. In some embodiments, a MaxID score for the user is also transmitted from the verification system 104. The MaxID score is a calculated limitless number (i.e., value) that incorporates all available user verification factors including, but not limited to, quantity and quality of current and previous biometric verifications, verification accuracy, previous verification patterns, verification location, social network verification, and verification device trust score. It will be noted that in step 220, data or information leaves the secure firewall of the verification system 104. The verification score and/or the MaxID score is then transmitted to an external entity in step 222. The external entity 222 may be the entity requesting the verification; for example it and may be the device from which the data was gathered in step 204. In other embodiments, the external entity of step 222 may be another device or application as shown in FIG. 1. As a result of the verification process, the external entity 222 receives the verification score and/or the MaxID score. The verification score may be expressed in some embodiments as a qualitative value (e.g., pass/fail, yes/no) and in other embodiments as a quantitative value (e.g., numerical value). The verification score and/or MaxID score may be used by the receiving entity to determine whether the privileges requested by the subject user are approved, including but not limited to: secure repository access, transaction approval, website and/or application access, etc.

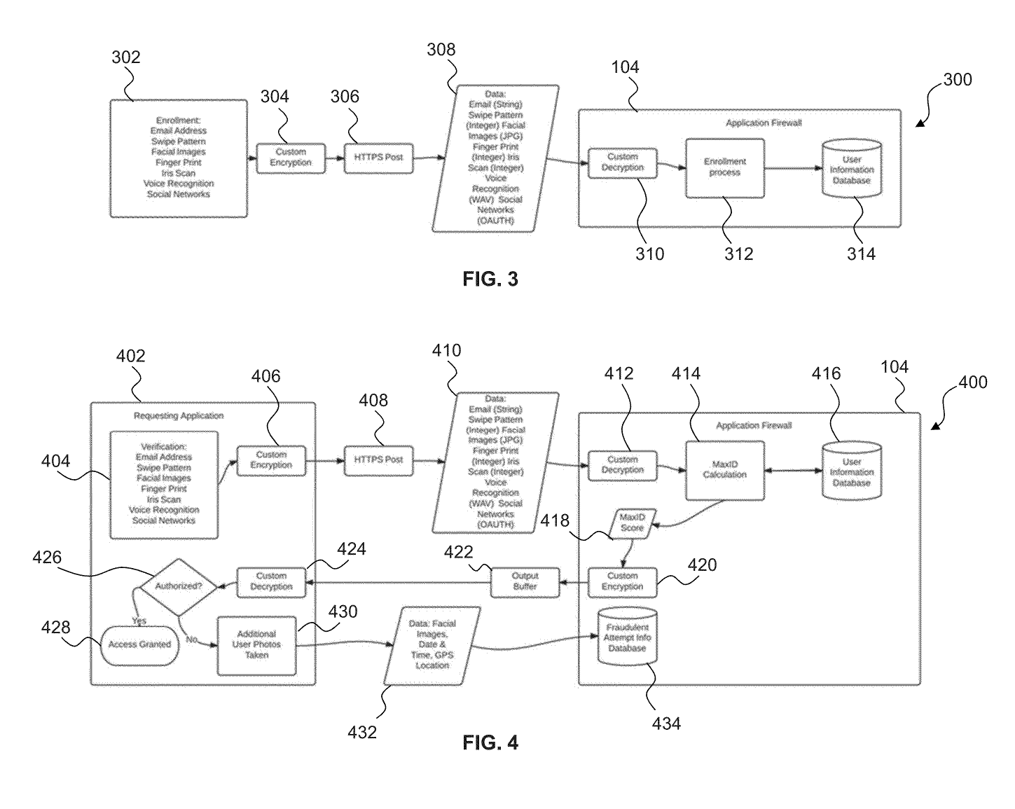

Referring to FIG. 3, one embodiment of a method 300 that may be used within the environment of FIG. 1 for a user driven biometric authentication process is illustrated. For example, a user may voluntarily or involuntarily perform an enrollment process in the verification system 104 of FIG. 1. A voluntary enrollment process occurs when the user cooperates in the submission of data/information, which may include biometric data/information, directly to the verification system. An involuntary enrollment process occurs when the verification system collects data/information regarding a user without the knowledge and/or cooperation of the user. An involuntary enrollment process may involve collection of user data from commercial databases, social media websites, web-crawler applications or other means.

In step 302, for example, as part of a voluntary enrollment process the user may register with the verification system and provide information/input to establish a baseline credential. For example, the baseline credential may include multiple user-specific characteristics including, but not limited to, unique swipe pattern(s) for use with finger swipe security interface(s), photos, facial images, finger prints, email, name, address, device information, network information, and geographic (i.e., “geo”) location. In steps 304 and 306, respectively, this information is encrypted and sent to the verification system 104 as illustrated in step 308. The custom encryption step 304 may include encryption with biometric keys or biometrically-derived keys, and the step 306 may include conventional encryption, for example using SSL (Secure Socket Layer) technology.

The step 308 shows the encrypted data package transmitted from the enrollment device to the verification system. The contents of the encrypted data package may include, but are not limited to data of the following types: email (string); swipe pattern (integer); facial images (JPG); finger print (integer); iris scan (integer); voice recognition (WAV); social networks (OAUTH). The encrypted data package 308 is then received through the firewall of the verification system 104 for decryption and verification assessment.

In steps 310-314, respectively, the encrypted data package is decrypted (step 310), and its information is processed (step 312), e.g., for enrollment, and stored in a user information database 314 (e.g., the user profile database 214 of FIG. 2). Once a baseline is established for the initial credential, the verification system 104 may “mine” public and private data sources to build an enhanced profile record for the user. Content such as photo or video images with known and verifiable association with the user are collected as part of the credential building process. Financial and transactional databases are utilized to further establish identity. For example, users may be questioned at random times regarding the same information (e.g., to select a number that coincides with their current mortgage payments from a list of possibilities or to identify what state they lived in when their social security number was issued).

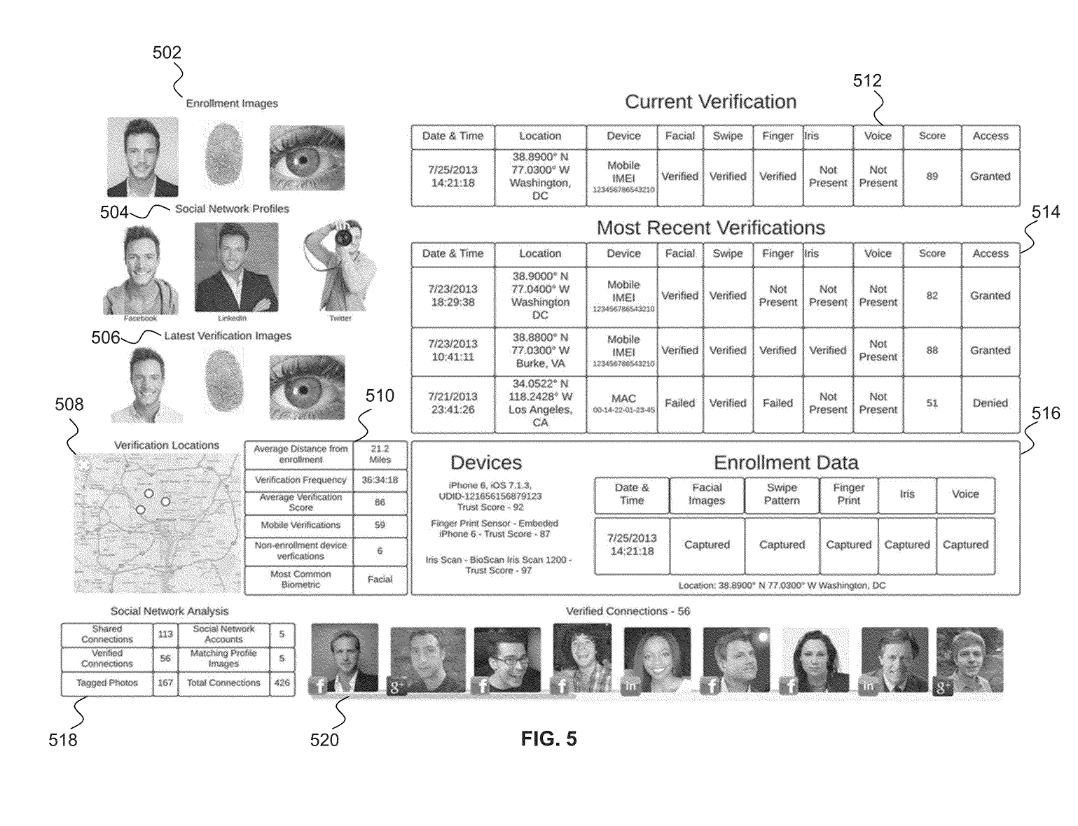

The verification system 104 continues to build a virtual identity dossier (see FIG. 5) on the user, further increasing in confidence and trust levels derived from the information collected. Since the verification system 104 knows the location of the user, information gathered regarding frequency of use at specific IP addresses, geo locations and MAC or EINS (i.e., device identities) further increases confidence levels in the user. Exceptions may be made for user travel. For example, a trust score may be temporarily reduced until supplemental verification questions can be answered to reestablish confidence levels.

A VerifyMe verification system (e.g., verification system 104) may use social network analysis including the capture of known “friends or associates” from cooperating entities, for example social media sites including, but not limited to, the Facebook™ social media service and the Linked In™ social media service. This information can be used to further establish user identity. The VerifyMe system is capable of polling these cooperating entities as to the validity of information presented to the VerifyMe system and/or the information provided as part of user profile, e.g., the enrollment profile. The VerifyMe system may serve the public as a central clearinghouse of routinely sought after information, for example past or present employer information, tenure, academic credentials, professional associations, verified job positions etc. Additionally, the VerifyMe system establishes a convincing association between a VerifyMe user and online identities by utilizing Social Network Login info, frequency location and device info to further enhance scoring capabilities with the VerifyMe system.

A VerifyMe verification system (e.g., verification system 104) may use multiple biometric identifiers to further establish user identity profiles. Biometic capabilities include facial recognition; since the VerifyMe system may continuously accumulate profile pictures of users (both voluntarily offered during the registration process and those acquired from Social networks, established news sources and photo and video albums of friends or associates), allowing the VerifyMe system to continuously refine scoring accuracies and authenticity of the user. The VerifyMe system may captures photos of VerifyMe system users even prior to login, which means if an attempt is being made to “spoof” the system, the VerifyMe system may have the ability to capture photo and video images of the individuals attempting to spoof or steal a user's identities. For example, even if someone has stolen an established VerifyMe system user's device and is able to acquire information such as passwords or swipe patterns, the VerifyMe system may be able to prevent unauthorized access by facial recognition comparisons. The VerifyMe system may then act to lock down the user account until identity authentication can be reestablished. Further, the VerifyMe system may provide appropriate law enforcement agencies with the acquired photo or video of the individuals attempting to perpetrate the identity theft. Further still, fingerprint scans may be retained and utilized as yet an addition method of authentication in similar fashion. Thus, potential identity thieves' fingerprints, facial images, etc. are retained by the verification system and may be provided to law enforcement should the need present itself for the purposes of prosecution. Similarly, iris-scan biometric techniques may be utilized in multiple ways which include conventional iris-scan for identity management and iris image refraction (i.e., viewing of images reflected in the iris). Other accommodations are made in the VerifyMe system repository for additional biometric identifies, for example voice recognition and gaze detection.

Referring to FIG. 4, one embodiment of a method 400 that may be used within the environment of FIG. 1 for an application driven biometric authentication process is illustrated. For example, an application 402 (e.g., a point of sale terminal or an ATM) may require that a user perform an authentication process in the verification system 104 of FIG. 1 prior to rendering services (e.g., completing a purchase or distributing cash). In this example, the requesting application 402 requests a MaxID score result instead of the verification score of the previous example (FIG. 3).

In step 404, information is obtained from the user. This information is custom encrypted in step 406 and posted to the verification system 104 in step 408 as illustrated in step 410. The custom encryption step 406 may include encryption with biometric keys or biometrically-derived keys, and the step 408 may include conventional encryption, for example using SSL (Secure Socket Layer) technology.

The step 410 transmits the encrypted data package from the requesting application 402 to the verification system 104. The contents of the encrypted data package may include, but are not limited to data of the following types: email (string); swipe pattern (integer); facial images (JPG); finger print (integer); iris scan (integer); voice recognition (WAV); social networks (OAUTH). The encrypted data package 410 is then received through the firewall of the verification system 104 for decryption and verification/MaxID assessment.

In step 412, the information is decrypted. In step 414, a MaxID calculation is performed using the received data and additional data from the user information database 416. The MaxID score is produced in step 418, encrypted in step 420, and sent to an output buffer 422. The application 402 decrypts the received score in step 424 and, in step 426, determines whether the MaxID score is sufficient to authorize the requested action. For example, the application 402 may compare the received MaxID score with a threshold score as previously described. If access is granted, the application 402 allows access in step 428. If access is not granted, the application 402 may take additional biometric data (e.g., additional photos) and transmit the photos along with other information (e.g., date, time, and location) as represented in step 432 to the verification system 104. The verification system 104 may store the received fraud information in a fraudulent attempt information database in step 434.

Referring to FIG. 5, one embodiment of information that may be stored by the verification system 104 of FIG. 1 for a user is illustrated. It is understood that the information presented, as well as the format and presentation of the information, is only one example and that many different types of information may be presented in many different ways.

In the present example, the information includes enrollment images 502, images from social network profiles 504, and recent verification images 506. Recent verification locations 508 may be presented as well as various metrics 510 that may be used to detect unusual or otherwise irregular activity. Information 512 may provide details about a current verification and information 514 may provide details about other recent verifications, including success or failure. Enrollment data 516 may include device information. Social network analysis information 518 and information regarding verified connections 520 may also be provided. This information may be stored in databases of the verification system 104, for example, in the user biometric database 210 or the user profile database 214 of FIG. 2, or the user information databases 314 and 416 of FIGS. 3 and 4, respectively.

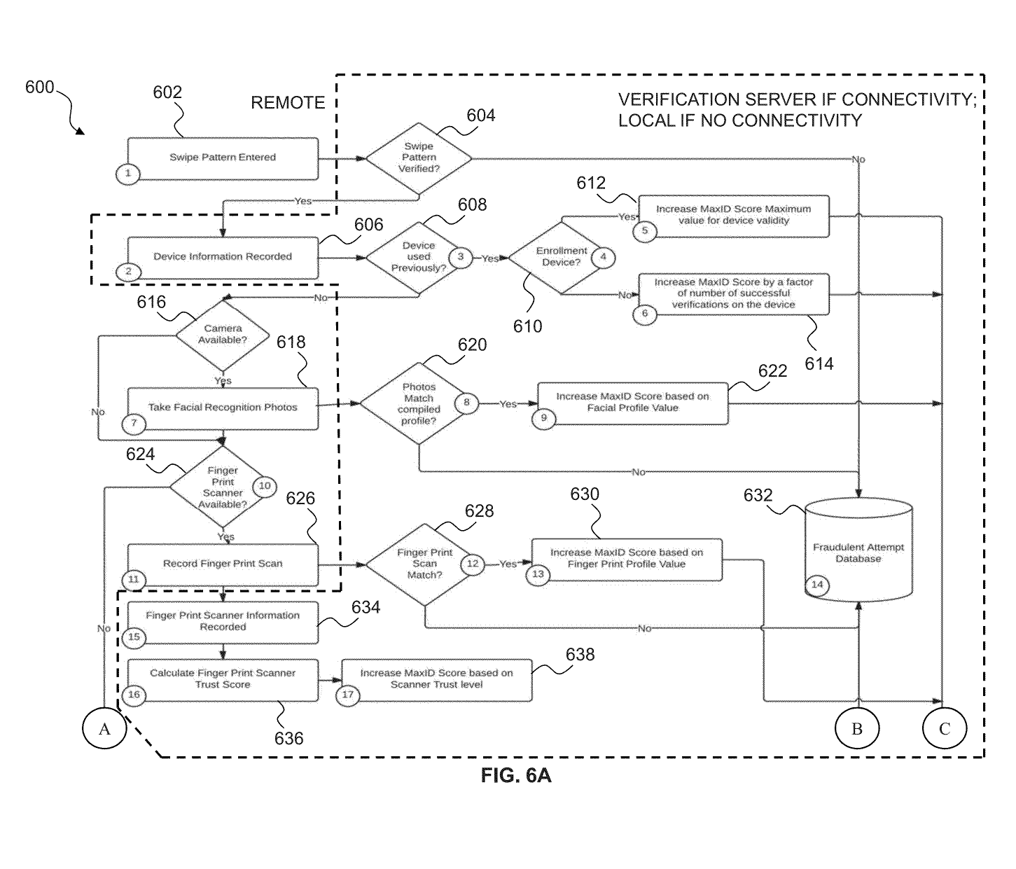

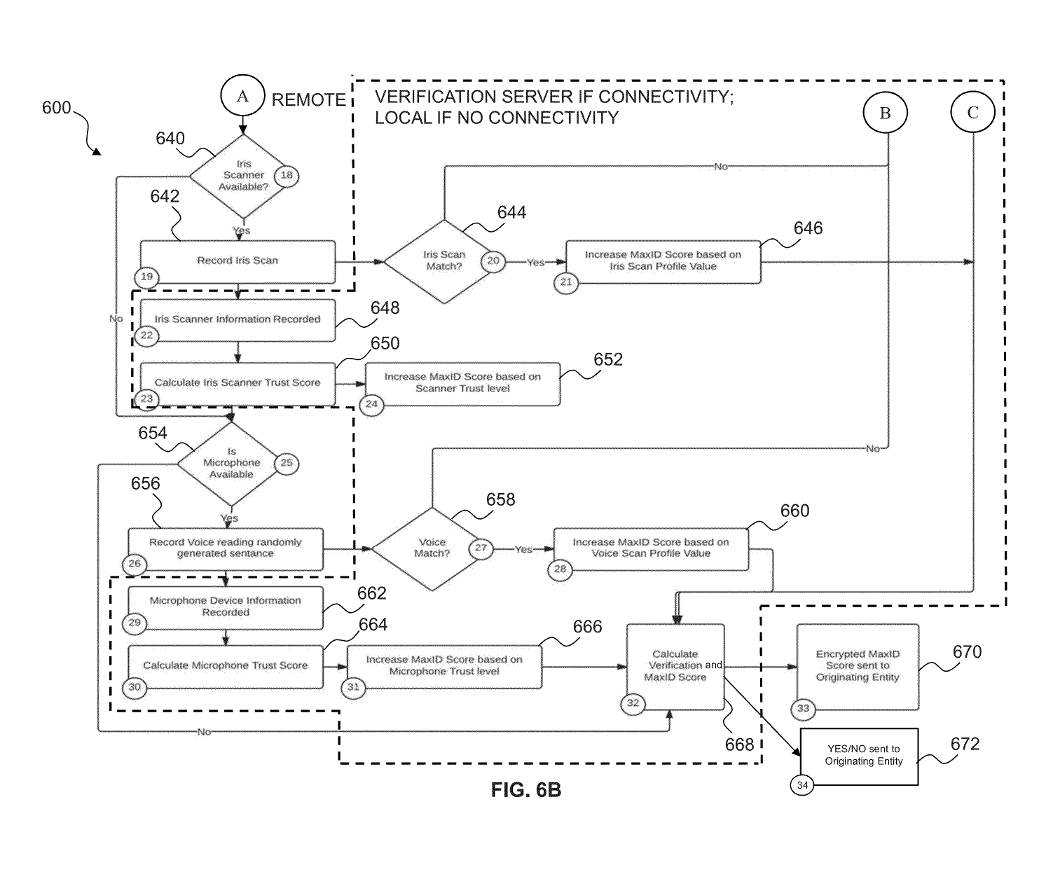

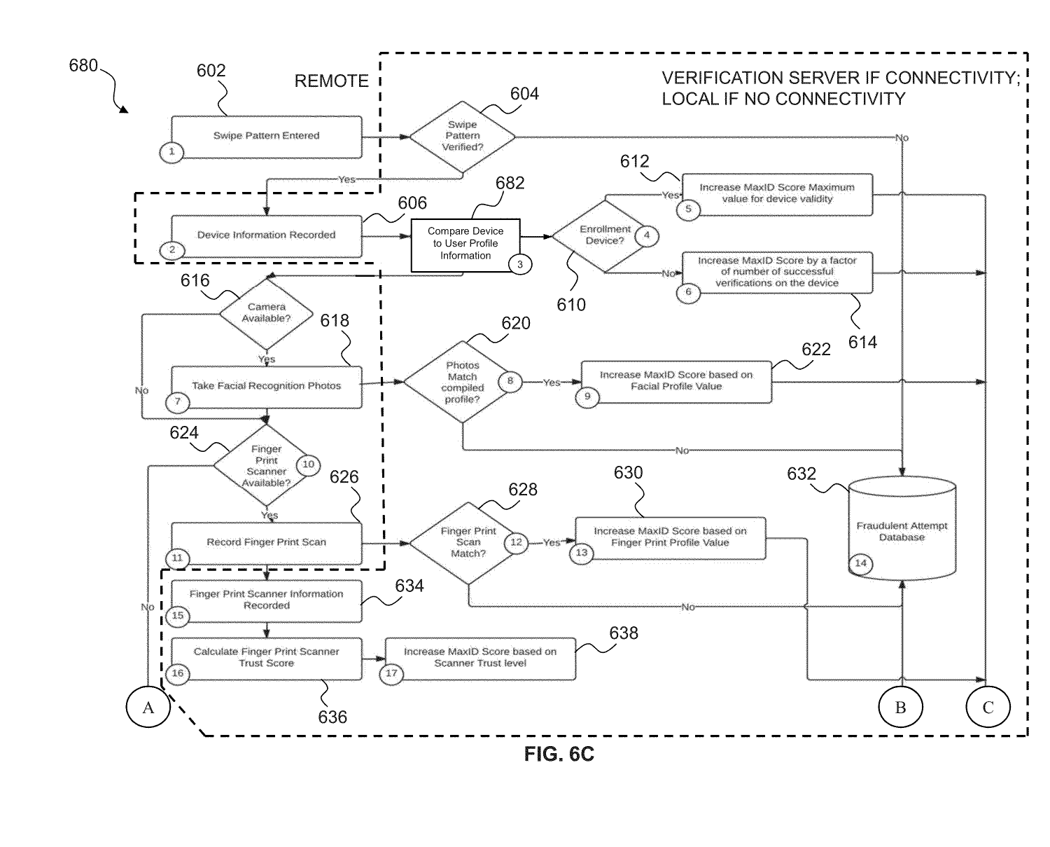

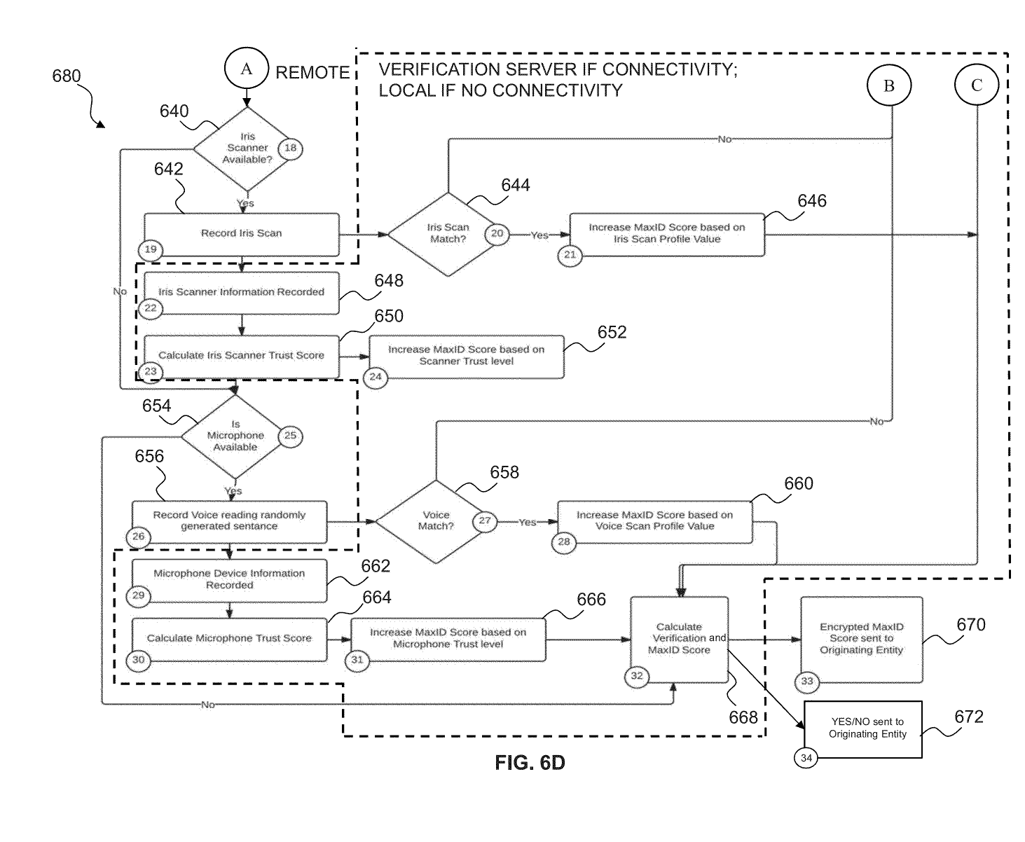

Referring to FIGS. 6A and 6B, one embodiment of a method 600 that may be used within the environment of FIG. 1 for a biometric authentication process is illustrated. In the present example, the method is divided into a first portion that is remote and a second portion that is performed by the verification system 104 if connectivity is available and is performed locally if no connectivity is available.

In step 602, a device access process, such as a swipe pattern detection and analysis process, may be performed. In step 604, a determination may be made as to whether device access is granted (e.g., was the swipe pattern properly performed). If device access is not granted, the information may be sent to and stored in the fraudulent attempt database as represented by step 632. If device access is granted, the method moves to step 606.

In step 606, the device information is recorded. In step 608, a determination is made as to whether the device has been used previously (e.g., whether its use has been previously recorded by the verification system 104). If the device has been used previously, the method moves to step 610, where a determination is made as to whether the device is an enrollment device. For example, the device may be listed in the enrollment information and the verification system 104 may have a relatively large amount of data on the device. If the device is an enrollment device, the method increases the MaxID score maximum value for the device's validity in step 612. If the device is not an enrollment device, the method increases the MaxID score based on the number of successful verifications performed by the device in step 614. Both steps 612 and 614 then move to step 668, which will be described later.

If the device has not been used previously as determined in step 608, the method moves to step 616. In step 616, a determination is made as to whether a camera is available. If a camera is available, photos are taken in step 618 for facial recognition. In step 620, a determination is made as to whether the photos match photos from the profile of the user attempting authentication. If the photos match, the method records the match as a positive input for calculating the verification score before moving to step 668. If the facial profile value from the step 618 is better than the value from the photo currently used by the system, the MaxID score may also be increased in step 622 and the new facial photo information may be used to replace the photo currently in the system. If the photos do not match, the method stores them in the fraudulent attempt database 632.

If there is not an available camera as determined in step 616, the method moves to step 624. In step 624, a determination is made as to whether there is a finger print scanner available. If a fingerprint scanner is available, fingerprint scans are recorded in step 626. In step 628, a determination is made as to whether the fingerprint scans match fingerprints from the profile of the user attempting authentication. If the fingerprint scans match, the method records the match for use in calculating the verification score and may increases the MaxID score based on the finger print profile value in step 630 before moving to step 668. If the fingerprint scans do not match, the method stores them in the fraudulent attempt database 632.

In addition to performing step 628 after step 626 if there is a fingerprint scanner, the method also moves to step 634 from step 626. In step 634, the fingerprint scanner information is recorded. In step 636, a fingerprint scanner trust score is calculated. In step 638, the MaxID score is increased based on the scanner trust level.

If there is not an available fingerprint scanner as determined in step 624, the method moves to step 640. In step 640, a determination is made as to whether there is an iris scanner available. If an iris scanner is available, an iris scan is recorded in step 642. In step 644, a determination is made as to whether the iris scan matches iris scans from the profile of the user attempting authentication. If the iris scans match, the method records the match for use in calculating the verification score and may increase the MaxID score based on the iris scan profile value in step 646 before moving to step 668. If the iris scans do not match, the method stores them in the fraudulent attempt database 632.

In addition to performing step 644 after step 642 if there is an iris scanner, the method also moves to step 648 from step 642. In step 648, the iris scanner information is recorded. In step 650, an iris scanner trust score is calculated. In step 652, the MaxID score is increased based on the scanner trust level.

If there is not an available iris scanner as determined in step 640, the method moves to step 654. In step 654, a determination is made as to whether there is a microphone available. If a microphone is available, a voice recording is made in step 656 of the user reading a randomly generated sentence. In step 658, a determination is made as to whether the voice recording matches voice recordings from the profile of the user attempting authentication. If the voice recordings match, the method records the match for use in calculating the verification score and the method may increase the MaxID score based on the voice scan profile value in step 660 before moving to step 668. If the voice recordings do not match, the method stores them in the fraudulent attempt database 632.

In addition to performing step 658 after step 656 if there is a microphone, the method also moves to step 662 from step 656. In step 662, the microphone device information is recorded. In step 664, a microphone trust score is calculated. In step 666, the MaxID score is increased based on the microphone trust level.

In step 668, which is reached via any of steps 612, 614, 622, 630, 646, 660, and 666, a verification score and a MaxID score are calculated. After encryption (not shown), the MaxID score may be sent in step 670 to the originating/requesting entity and/or the verification score may be sent in step 672 to the originating/requesting entity. It will be appreciated that the originating/requesting entities of steps 670 and 672 may not necessarily be the same entity.

Referring to FIGS. 6C and 6D, another embodiment of a method 680 that may be used within the environment of FIG. 1 for a biometric authentication process is illustrated. The method 680 is substantially identical to the method 600 previously discussed, except for a comparison step 682 (FIG. 6C), which replaces the decision step 608 (FIG. 6A). The comparison step 680 routes the process flow of the method 680 to both the “Enrollment Device?” decision step 610 and the “Camera Available?” decision step 616. In this manner, the various biometric sensing devices that may be available at the remote portion of the system may be utilized whether the swipe pattern device of step 602 has been used previously or not.

In another aspect of the invention, an advanced multi-modal biometric method is provided for single sign-on authentication, payment presentment and auto-field population for authorized web sites. This invention utilizes a combined biometric authentication approach, i.e., two or more biometric tests including, but not limited to, fingerprint, facial recognition, iris-scan, voice or touch point swipe, for the purposes of establishing the identity of the user and that the user is live. The method is especially useful when presenting such credentials for authentication and verification.

The techniques used in this process incorporates some of U.S. Pat. No. 7,519,558 with additional consideration for the innovations and novelty as detailed above. Additionally, once user is authenticated and devices verified as “trusted” said invention gives user the opportunity to securely store payment information and “secured and verified” auto field population content that can be populated and acknowledged as verified to online entities and/or websites for the purpose of mitigating fraud and identity theft typically associated with such transactions. In essence the VerifyMe verification system becomes the “identity notary” over the web and any network. Further enhancements to U.S. Pat. No. 7,519,558 allows for this system to incorporate additional “trust” factors via social networking corroboration and the use of negative databases to routinely increase the confidence levels of the users being authenticated.

In another aspect, a combined biometric authentication approach uses two or more items of biometric data including, but not limited to, fingerprint, facial recognition, iris scan, voice or touch-point swipe, for the purposes of establishing the identity of the user and that the user is live when presenting such credentials for authentication and verification.

Initially, a user registers and establishes a baseline credential, which may include a unique swipe pattern, an email address, a name, a physical address, device information, network information and/or geographic location.

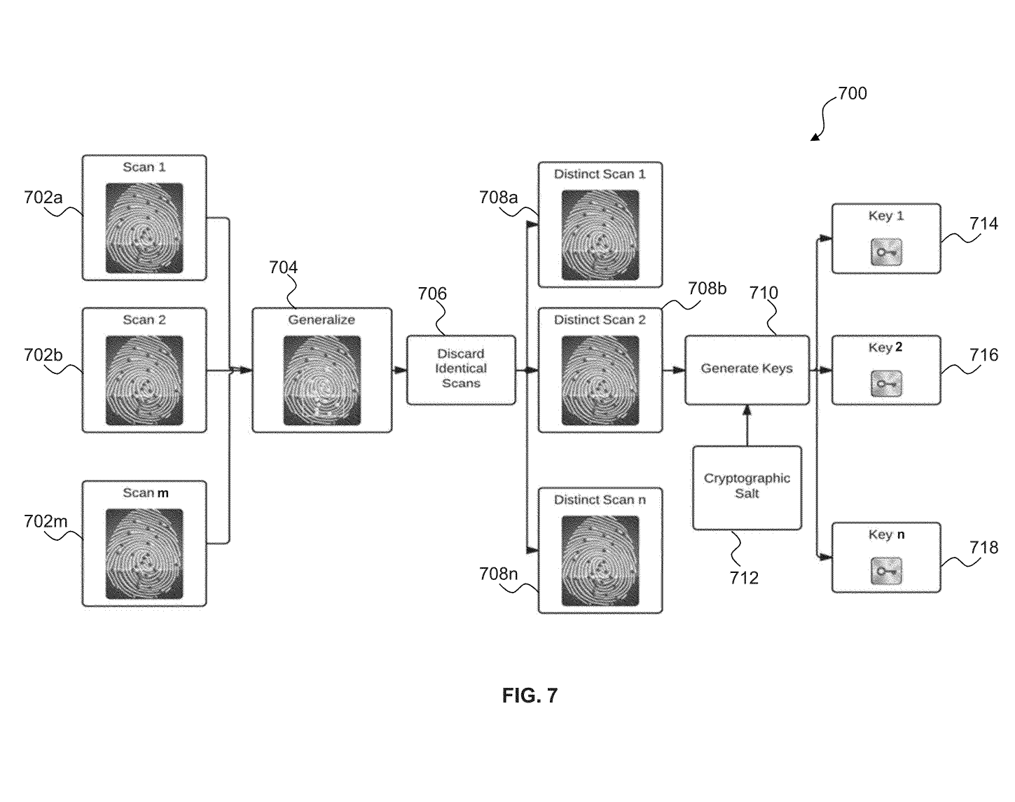

Referring generally to FIGS. 7-12, there are illustrated methods of generating encryption keys and decryption keys from biometric inputs in accordance with another aspect. The exact same key used to encrypt the data payload should be supplied to the decryption algorithm in order to get the cipher text decrypted. A digitized biometric feature captured from the same biometric source virtually never produces the exact same data sequence and the comparison of such biometric features are carried out by adding levels of approximations and heuristics to the biometric features. Decrypting the encrypted cipher text cannot involve comparing the scanned biometric data with previously recorded biometric information, since transmitting it would risk the security of the system.

Referring first to FIG. 7, there is illustrated a method of creating keys from biometric inputs. A method 700 for creating a secure encryption key from a biometric feature includes executing multiple captures 702a, 702b, . . . , m of same biometric feature covering almost all of the possible combinations of ways in which a feature could be scanned. This one time process would create a master set of that particular biometric feature, all of which would be passed through a generalization algorithm 704 that would exclude the points in the minutiae set that may not be possibly captured in another scan of the same biometric feature. Some of the resulting scans may be exact copies of other scans in the master set after generalization. Such duplicates are discarded (step 706) and a subset of generalized, distinct scans 708a, 708b, . . . , n are obtained and then each of these scan results are converted into fixed length keys 714, 716, 718.

In step 710, generating fixed length keys 714, 716, 718 from generalized biometric scans involves a password based key derivation function which takes a cryptographic salt 712 and a count of iterations required, along with the variable length string from the generalized biometric scan. The cryptographic salt 712 can be chosen based on any data that is guaranteed to be available at the time of decryption, this would increase the security of the encryption further. If user decides to enforce a limitation on decryption to a specific device, specific biometric hardware, a time window, a geographical location or a combination of two or more of these conditions, these can be used as the parameters to produce the cryptographic salt.

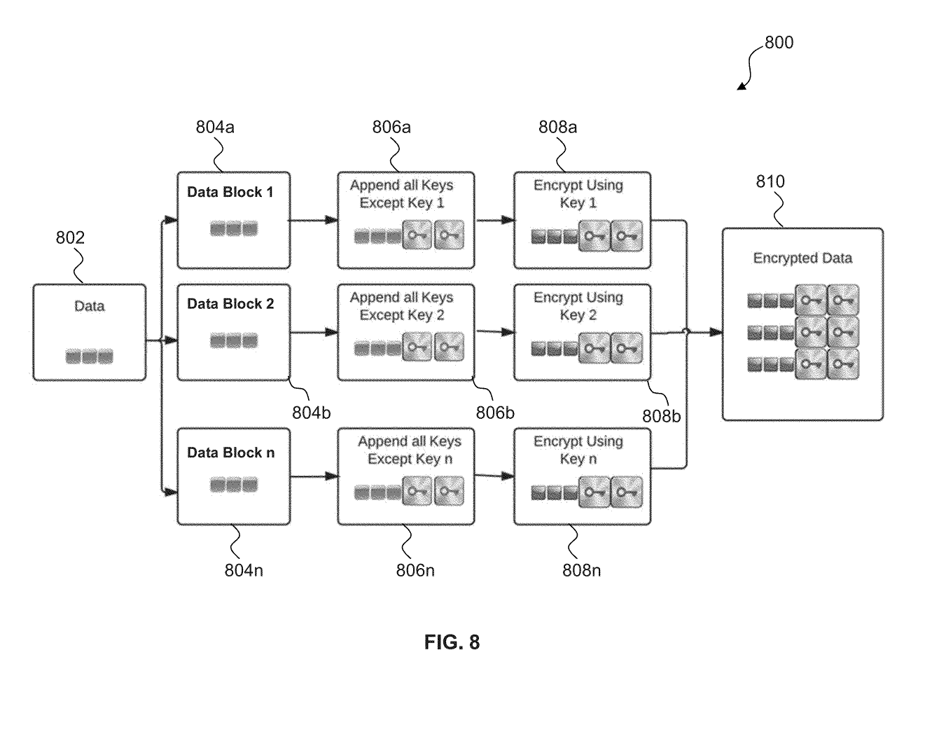

Referring now to FIG. 8, a method of encryption is illustrated. In the encryption method 800, the data 802 to be encrypted is divided (steps 804a, 804b, . . . , n) into the number of keys available, and encrypted (step 808a, 808b, . . . , n) using each of the available keys. During encryption (steps 806a, 806b, . . . , n), each block will also be appended with all the keys except the one that's about to be used to encrypt the specific block. After encryption, in step 810, the blocks are combined into a single encrypted data package.

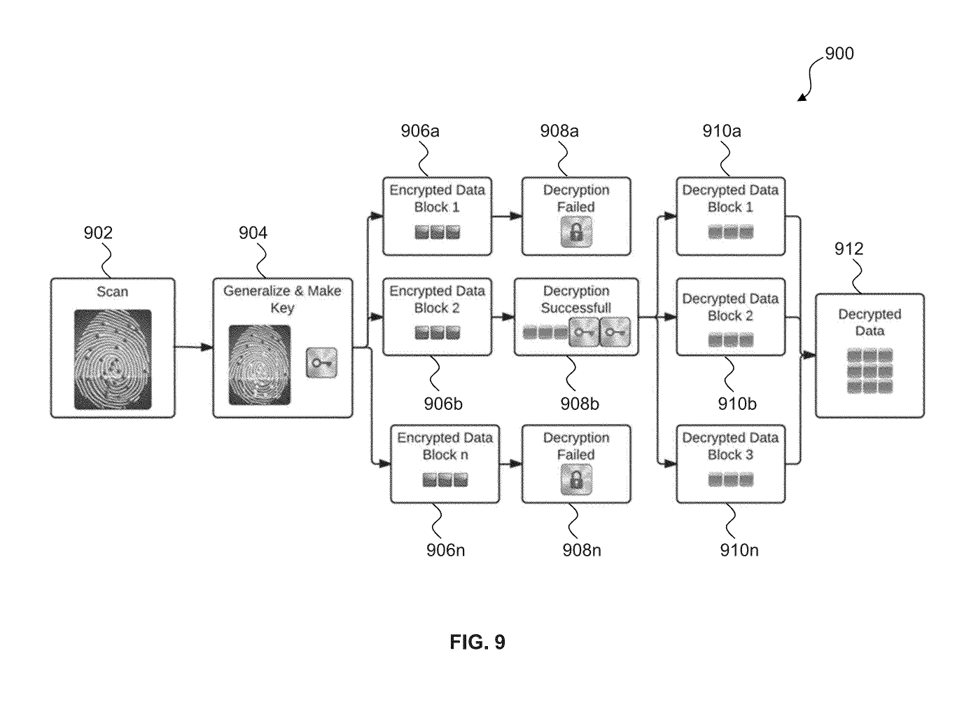

Referring now to FIG. 9, a method of decryption is illustrated. During decryption method 900, the same biometric feature of the user is scanned (step 902) and generalized and used to generate the fixed length key (step 904) using the same algorithm used while generating the keys for encryption. The encrypted data is divided into blocks (step 906a, 906b, . . . , n) and then the generated key is attempted (step 908a, 908b, . . . , n) on each of the blocks for possible decryption. The first block that get decrypted successfully, in this case, step 908b, gives the keys to decrypt the other blocks (step 910a, 910b, . . . , n) as well resulting in the complete decrypted data by combining (step 912) all decrypted blocks after the removal of appended keys to each block.

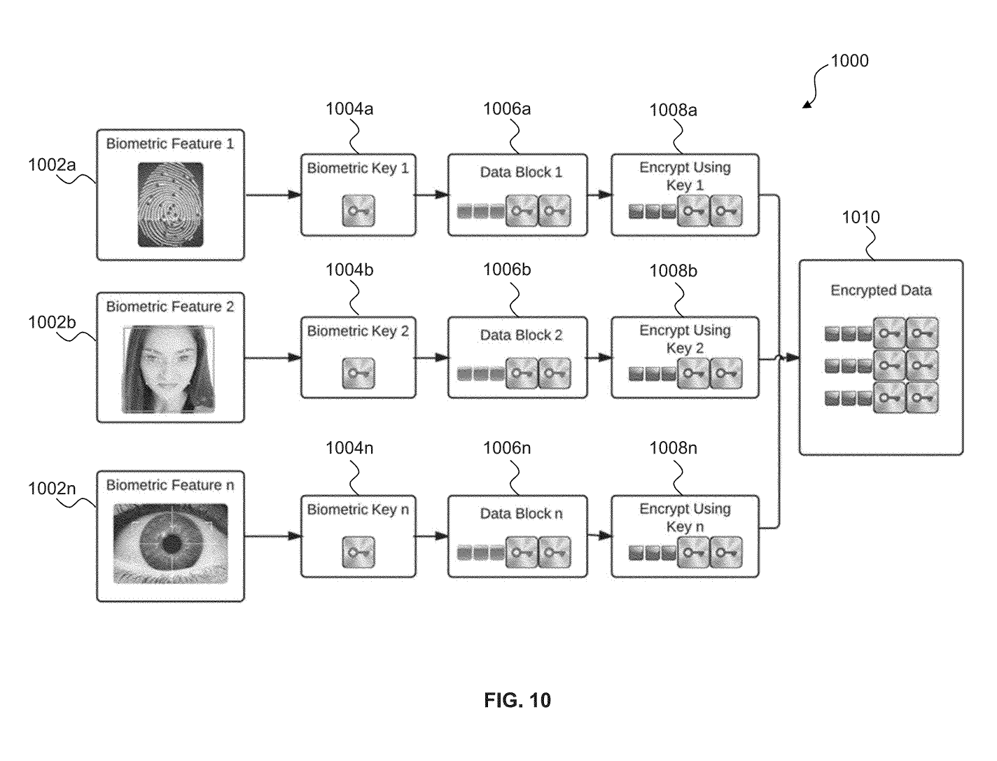

Referring now to FIG. 10, a method for multi-biometric encryption is illustrated. In method 1000, if the user requires the biometrically encrypted data to be decrypted by any of their biometric features (1002a, 1002b, . . . , n), the encryption must involve all of the biometric features that the user would like to use at the time of decryption. Each of the biometric features is scanned multiple times creating multiple fixed length keys (step 1004a, 1004b, . . . , n). The complete set of keys generated from all of the biometric features is used for the encryption of the data (step 1008a, 1008b, . . . , n) by dividing the payload (step 1006a, 1006b, . . . , n) into the number of keys and using each of the keys for each block. All of the blocks will also be appended with all of the keys except the key used in the encryption of the particular block. After encryption of each block, the data is combined (step 1010) into a single encrypted data package.

During the decryption of multi-biometric encrypted data, the user provides any one of the biometric inputs which was included at the time of encryption. For example, the necessary biometric input may be obtained from the user biometric database 210 (FIG. 2). The key generated from the biometric input is tried sequentially with all of the encrypted blocks one by one until a successful decryption occurs. The decrypted blocks then contain the keys to decrypt the other blocks and thus the entire data is decrypted.

Since the decryption technique considers only about the number of blocks and keys used and not about the biometric feature that was used to encrypt it, the decryption of a multi-biometric encryption can be carried out by the same decryption process that is designed to decrypt a single biometric encryption. This eliminates the necessity to indicate the number of biometrics features involved in the encryption of the data, thus adding further to the security factor.

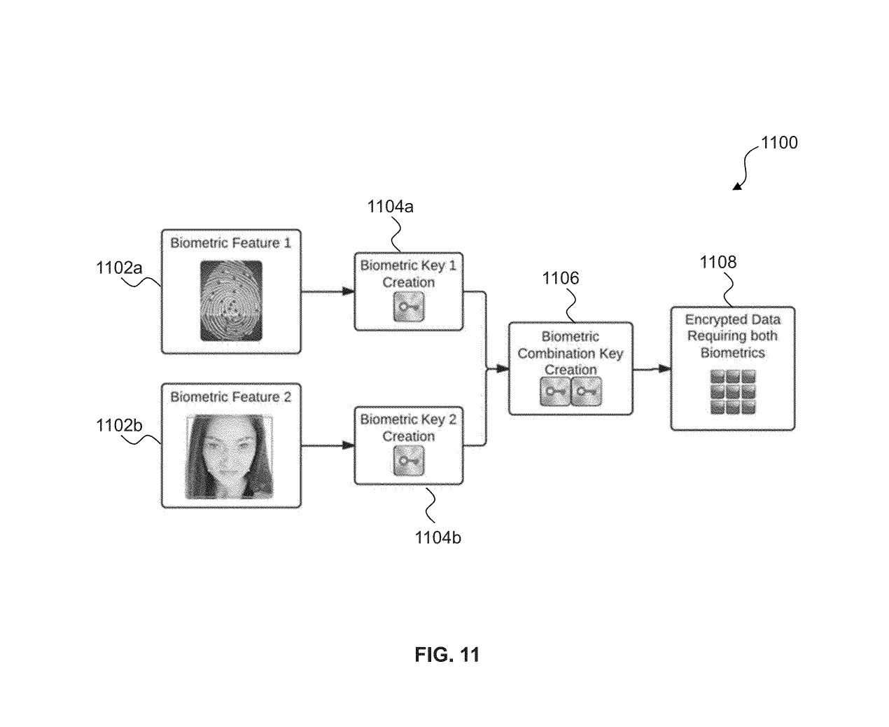

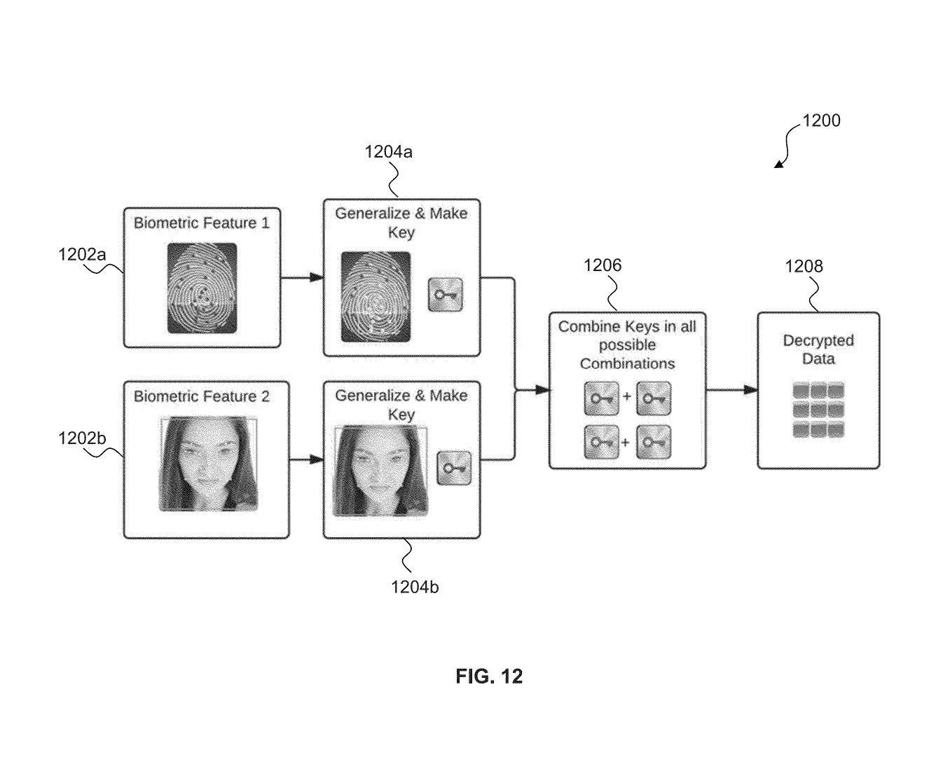

Referring to FIG. 11, a method for encrypting data with combinations of biometric inputs is illustrated. In method 1100, the user can choose to protect the sensitive information by encrypting with multiple biometric inputs 1102a, 1102b which would thus require the user to validate all of the biometric inputs provided at the time of encryption for the successful decryption of the data. This is achieved by creating an encryption key (step 1106) which combines all of the biometric data produced at the time of encryption.

The number of keys thus produced will be equal to the permutations of the total number of generalized biometric scans available and the number of biometric features used.

If biometric feature 1 (1102a) produces b1 number of unique generalized scans and if biometric feature 2 (1102b) produces b2 number of unique generalized scans, the number of keys 1104a, 1104b generated for encrypting the data 1108 with these two biometric features would be the product (step 1106) of these keys.

Referring now to FIG. 12, a method for decryption of data encrypted with combinations of biometric inputs is illustrated. The decryption process 1200 remains the same as previously described (FIG. 9) until the decryption key generation process. In this case, the key is produced after collecting the scans of the required biometric inputs 1202a, 1202b from the user, then combining the generalized results (step 1204a, 1204b) into the single fixed length key (step 1206), which is tried on all the blocks until successful decryption occurs (step 1208) which would release the keys to decrypt all the other blocks. Considering the fact that the user may provide the biometric input not in the exact order provided at the time of encryption, multiple combination keys need to be generated by using all sequential orders of the user inputs. All of these keys are tried one by one until a successful decryption occurs.

To perform generalization of biometric inputs, the scanned Biometric Inputs are supplied to a feature extraction algorithm which finds the unique characteristic information and points from the biometric scan. In a regular scenario, the resulting data would be stored untouched and when it has to be compared to another scan of the same biometric input, the comparison algorithm makes necessary modifications such as stretch, skew, resize, rotate and quantize the two biometric inputs suitably to make them eligible for a one to one comparison. Also, such comparison algorithms will report a positive identification if the percentile of the match falls within the predefined threshold.

Encrypting the data directly with such high entropy input as the encryption key may result in unacceptable levels of decryption failures even with several rescans of the associated biometric input.

Key Points regarding encryption are as follows:
a) Two scans of same biometric feature virtually never generate same set of data.
b) Biometric verification algorithms works on approximate comparisons between two or more scans.
c) For Decryption no previous scans are available for comparison
d) Neither the Encryption key nor the biometric input that was used to create the key can be recovered from the encrypted data.

Hence to ensure a guaranteed decryption, the biometric input that we use must be carefully screened to find what part of it will be used in the generation of the key. This process may include most of all of the techniques such as avoiding the less prominent features that are possible to be missing in another instance of the scan, filtering, normalization and quantization, after which the resulting data could be used for the generation of the encryption key. During decryption key generation, if a feature of the biometric input has equal probability for inclusion and exclusion in the key generation data, the decryption engine could be designed to generate two keys, with and without the feature which is under suspicion. Both the keys would be tried one after the other for decryption. All of these combined, the probability of the data getting decrypted in a single attempt would reach the acceptable level.

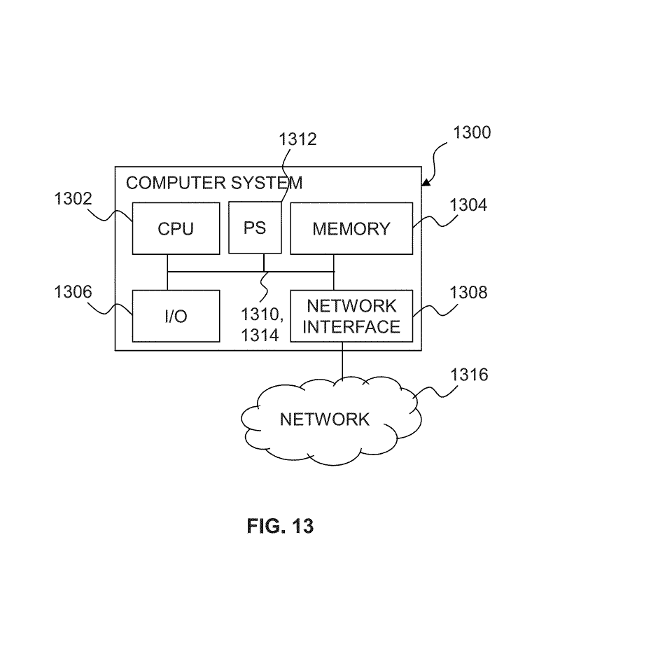

Referring to FIG. 13, one embodiment of a device 1300 is illustrated. The device 1300 is one possible example of a system component or device that may be used within the environment 100 of FIG. 1. The device 1300 may include a controller (e.g., a central processing unit (“CPU”)) 1302, a memory unit 1304, an input/output (“I/O”) device 1306, and a network interface 1308. The components 1302, 1304, 1306, and 1308 are interconnected by a data transport system (e.g., a bus) 1310. A power supply (PS) 1312 may provide power to components of the device 1300 via a power transport system 1314 (shown with data transport system 1310, although the power and data transport systems may be separate).

It is understood that the device 1300 may be differently configured and that each of the listed components may actually represent several different components. For example, the CPU 1302 may actually represent a multi-processor or a distributed processing system; the memory unit 1304 may include different levels of cache memory, main memory, hard disks, and remote storage locations; the I/O device 1306 may include monitors, keyboards, and the like; and the network interface 1308 may include one or more network cards providing one or more wired and/or wireless connections to a network 1316. Therefore, a wide range of flexibility is anticipated in the configuration of the device 1300, which may range from a single physical platform configured primarily for a single user to a distributed platform such as a cloud computing system.

The device 1300 may use any operating system (or multiple operating systems), including various versions of operating systems provided by Microsoft (such as WINDOWS), Apple (such as Mac OS X), UNIX, and LINUX, and may include operating systems specifically developed for handheld devices, personal computers, and servers depending on the use of the device 1300. The operating system, as well as other instructions, may be stored in the memory unit 1304 and executed by the processor 1302. For example, the memory unit 1304 may include instructions for performing some or all of the methods described herein.

The network 1316 (which may be similar or identical to the network 106 of FIG. 1) may be a single network or may represent multiple networks, including networks of different types. For example, the network 1316 may include one or more cellular links, data packet networks such as the Internet, local area networks (LANs), and/or wide local area networks (WLAN), and/or Public Switched Telephone Networks (PSTNs). Accordingly, many different network types and configurations may be used to couple the device 1300 to other components of the environment 100 of FIG. 1.

Although the preferred embodiment has been described in detail, it should be understood that various changes, substitutions and alterations can be made therein without departing from the spirit and scope of the invention as defined by the appended claims.

It will be appreciated by those skilled in the art having the benefit of this disclosure that this system and method for multi-modal biometric identity verification provides significant advantages over previous systems. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for execution by a verification system comprising:
receiving, by the verification system, a request from a device to verify an identity of a user of the device, wherein the request includes a data payload encrypted using a plurality of first keys derived from a first biometric minutia set, wherein the first biometric minutia set is derived from first biometric data obtained by the device for the request from at least one biometric feature of the user, and wherein the first biometric minutia set is only a subset of the first biometric data;
retrieving, by the verification system, second biometric data from a database, wherein the second biometric data corresponds to an enrolled user having a maximum identification (MaxID) score associated therewith within the verification system;
generating, by the verification system, a second biometric minutia set from the second biometric data;
generating, by the verification system, a second key derived from the second biometric minutia set;
decrypting, by the verification system, the data payload using the second key;
extracting, by the verification system, third biometric data from the data payload, wherein the third biometric data was obtained by the device for the request from at least one biometric feature of the user;
comparing, by the verification system, the third biometric data to fourth biometric data corresponding to the enrolled user to produce a comparison result;
identifying, by the verification system using the comparison result, a value representing a probability that the third biometric data matches the fourth biometric data; and
acting, by the verification system, on the value, wherein the acting includes calculating a verification score representing a level of confidence by the verification system that the user of the device is the enrolled user if the value meets or exceeds a threshold value and sending the verification score or a representation thereof to the device.

2. The method of claim 1 wherein the first biometric minutia set is identical to the third biometric data and the second biometric minutia set is identical to the fourth biometric data.

3. The method of claim 1 wherein the first biometric minutia set is different from the third biometric data and the second biometric minutia set is different from the fourth biometric data.

4. The method of claim 1 wherein the verification score is calculated based on the MaxID and the value.

5. The method of claim 1 wherein the acting further includes storing the third biometric data as fraudulent if the value does not meet or exceed the threshold value.

6. The method of claim 1 wherein the verification score is expressed as a qualitative value.

7. The method of claim 1 wherein the verification score is expressed as a quantitative value.

8. The method of claim 1 wherein decrypting the data payload includes:
attempting to decrypt each of a plurality of separately encrypted blocks in the data payload using the second key until a single one of the blocks is successfully decrypted because the second key matches the first key used to encrypt that block;
extracting a remaining plurality of the first keys from the decrypted block; and
decrypting the remaining blocks using the remaining plurality of first keys.

9. A method for execution by a device comprising:
receiving, by the device, an access request from a user of the device;
obtaining, by the device, first biometric data from the user in response to the access request;
generating, by the device, a biometric minutia set from the first biometric data;
generating, by the device, a plurality of encryption keys from the biometric minutia set;
encrypting, by the device using the encryption keys, a data payload containing second biometric data obtained from the user;
sending, by the device, a verification message to a verification system, wherein the verification message contains the encrypted data payload and requests that the verification system verify an identity of the user based on the encrypted data payload; and
receiving, by the device, a response to the request, wherein the response indicates whether the access request is to be granted based on whether the identity of the user was verified.

10. The method of claim 9 wherein the first biometric data is identical to the second biometric data.

11. The method of claim 9 wherein the first biometric minutia set is identical to the second biometric data.

12. The method of claim 9 wherein generating the plurality of encryption keys includes:
obtaining a plurality of unique scans from the first biometric data;
generalizing the unique scans to exclude any point not replicated in each scan;
discarding any duplicative scans from the generalized scans to identify a plurality of distinct scans; and
generating a separate encryption key for each of the distinct scans.

13. The method of claim 12 wherein encrypting the data payload includes:
dividing the data payload into a number of sections equal to the number of separate encryption keys; and
encrypting each section with a single one of the encryption keys.

14. The method of claim 13 further comprising, for each section, appending the encryption keys not used to encrypt the section to the section before encrypting the section.

15. A verification system comprising:
a network interface;
a processor coupled to the network interface;
a memory coupled to the processor and containing instructions for execution by the processor, the instructions including instructions for:
receiving a request from a device via the network interface to verify an identity of a user of the device, wherein the request includes a data payload encrypted using a plurality of first keys derived from a first biometric minutia set, wherein the first biometric minutia set is derived from first biometric data obtained by the device for the request from at least one biometric feature of the user, and wherein the first biometric minutia set is only a subset of the first biometric data;
retrieving second biometric data from a database, wherein the second biometric data corresponds to an enrolled user having a maximum identification (MaxID) score associated therewith within the verification system;
generating a second biometric minutia set from the second biometric data;
generating a second key derived from the second biometric minutia set;
decrypting the data payload using the second key;
extracting third biometric data from the data payload, wherein the third biometric data was obtained by the device for the request from at least one biometric feature of the user;
comparing the third biometric data to fourth biometric data corresponding to the enrolled user to produce a comparison result;
identifying, using the comparison result, a value representing a probability that the third biometric data matches the fourth biometric data; and
acting on the value, wherein the acting includes calculating a verification score representing a level of confidence by the verification system that the user of the device is the enrolled user if the value meets or exceeds a threshold value and sending the verification score or a representation thereof to the device.

16. The system of claim 15 wherein the first biometric minutia set is identical to the third biometric data and the second biometric minutia set is identical to the fourth biometric data.

17. The system of claim 15 wherein the first biometric minutia set is different from the third biometric data and the second biometric minutia set is different from the fourth biometric data.

18. The system of claim 15 wherein the verification score is calculated based on the MaxID and the value.

19. The system of claim 15 wherein the verification score is expressed as a qualitative value.

20. The system of claim 15 wherein the verification score is expressed as a quantitative value.
